(19) United States
(12) Patent Application Publication
(10) Pub. No.: US 2009/0304263 A1
(43) Pub. Date: Dec. 10, 2009

(54) Method for classifying an object using a stereo camera

(76) Inventors: Thomas Engelberg, Hildesheim (DE); Wolfgang Niem, Hildesheim (DE)

Correspondence Address: KENYON & KENYON LLP, ONE BROADWAY, NEW YORK, NY, 10004, US

(21) Appl. No.: 10/589,641

(22) PCT Filed: Dec. 8, 2004
(86) PCT No.: PCT/EP2004/053350

§ 371 Date: May 13, 2009

(30) Foreign Application Priority Data
Feb. 13, 2004 (DE) 102004007049.0

(51) Int. Cl. G06K 9/00

(52) U.S. Cl. 382/154

(57) ABSTRACT

A method is provided for classifying an object using a stereo camera, the stereo camera generating a first and a second image using a first and a second video sensor respectively. In order to classify the object, the first and the second image are compared with one another in predefined areas surrounding corresponding pixel coordinates, the pixel coordinates for at least one model, at least one position and at least one distance from the stereo camera being made available.

### FIELD OF THE INVENTION

The present invention is directed to a method for classifying an object using a stereo camera.

### BACKGROUND INFORMATION

Classification of an object using a stereo camera, in which classification is performed based on head size and, respectively, head shape, is known from German Published Patent Application No. 199 32 520.

### SUMMARY OF THE INVENTION

By contrast, the method according to the present invention for classifying an object using a stereo camera has the advantage over the related art that model-based classification is now performed based on table-stored pixel coordinates of the stereo camera's left and right video sensors and their mutual correspondences. The models are stored for various object shapes and for various distances between the object and the stereo camera system. If, in terms of spatial location, an object to be classified is located between two stored models of this kind, classification is then based on the model that is closest to the object. By using the stored pixel coordinates of the stereo camera's left and right video sensors and their mutual correspondences, it is possible to classify three-dimensional objects solely from grayscale or color images. The main advantage over the related art is that there is no need for resource-intensive and error-prone disparity and depth value estimates. This means the method according to the present invention is significantly simpler. In particular, less sophisticated hardware may be used. Furthermore, classification requires less processing power. Moreover, the classification method allows highly reliable identification of the three-dimensional object. The method according to the present invention may in particular be used for video-based classification of seat occupancy in a motor vehicle. Another application is for identifying workpieces in manufacturing processes.

The basic idea is to make a corresponding model available for each object to be classified. The model is characterized by 3D points and the topological combination thereof (e.g., triangulated surface), 3D points 22 which are visible to the camera system being mapped to corresponding pixel coordinates 24 in left camera image 23 and pixel coordinates 26 in right camera image 25 of the stereo system (see FIG. 2). The overall model having 3D model points and the accompanying left and right video sensor pixel coordinates is stored in a table as shown in FIG. 6 (e.g., on a line-by-line basis) so that the correspondence of the pixels of the left and right camera is unambiguous. This storing may be accomplished in the form of a look-up table that allows fast access to the data. The captured left and right camera grayscale values are compared in a defined area surrounding the corresponding stored pixel coordinates. Classification is performed as a function of this comparison. The model for the values of which comparison indicates the highest degree of concordance is then used.

It is particularly advantageous that for each individual comparison a quality index is determined, the object being classified as a function of this quality index. The quality index may be derived from suitable correlation measurements (e.g., correlation coefficient) in an advantageous manner.

Furthermore, it is advantageous that the models are generated for a shape, e.g., an ellipsoid, for different positions or distances relative to the camera system. For example, as a general rule three different distances from the camera system are sufficient to allow an object on a vehicle seat to be correctly classified. Different orientations of the object may also be adequately taken into account in this way. If necessary, suitable adjustment methods may additionally be used.

### BRIEF DESCRIPTION OF THE DRAWINGS

FIG. 1 shows a block diagram of a device for the method according to the present invention.

FIG. 2 shows mapping of the points of a three-dimensional object to the image planes of two video sensors of a stereo camera.

FIG. 3 shows a further block diagram of the device.

FIG. 4 shows a further block diagram of the device.

FIG. 5 shows a further block diagram of the device.

FIG. 6 shows a table.

FIG. 7 shows a further block diagram of the device.

### DETAILED DESCRIPTION

As a general rule, known methods for model-based classification of three-dimensional objects using a stereo camera may be divided into three main processing steps.

In a first step, using data from a stereo image pair a displacement for selected pixels is estimated via disparity estimates and converted directly into depth values and a 3D point cloud. This is the stereo principle.

In a second step, this 3D point cloud is compared with various 3D object models which are represented via an object surface description. Herein, for example, the mean distance between the 3D points and the surface model in question may be defined as the measure of similarity.

In a third step, assignment to a class is performed by selecting the object model having the greatest degree of similarity.

To avoid having to determine depth values, according to the present invention it is proposed that classification is carried out solely based on comparison of the measured grayscale or color images (=images) with stored left and right stereo system camera pixel coordinates and their mutual correspondences. The stored pixel coordinates are generated by using the stereo system's left and right camera images to map surfaces of 3D models representing the objects to be classified. It is possible to classify objects in various positions and at various distances from the stereo camera system, because the accompanying models representing the particular objects are available for various positions and various distances. For example, if an ellipsoid-shaped object, for which the distance from the stereo camera system may vary, is to be classified, the corresponding model of the ellipsoid is made available for various different distances from the stereo camera system.

In the case of the classification method according to the present invention, first, in a preprocessing step, the models representing the objects to be classified must be made available. If for example the method according to the present invention is to be used to classify seat occupancy in a motor vehicle, this is carried out at the plant. Herein, various shapes to be classified, e.g., a child in a child seat, a child, a small adult, a large adult, or just the head of an adult or child, are used to generate models. The left and right stereo system camera pixel coordinates and their mutual correspondences are suitably stored (e.g., in a look-up table) for these models, which may be at a variety of defined distances from the stereo system. Using a look-up table means the search for the model having the highest degree of concordance with the object detected by the stereo camera system is less resource-intensive.

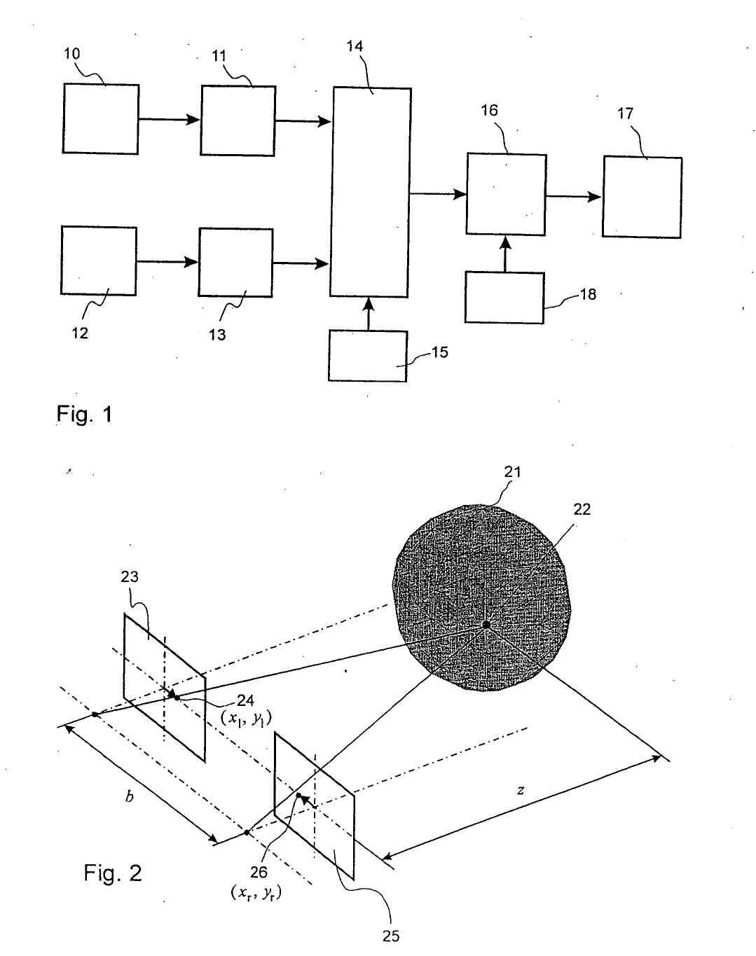

FIG. 1 shows a device used to implement the method according to the present invention. A stereo camera which includes two video sensors 10 and 12 is used to capture the object. A signal processing unit 11, in which the measured values are amplified, filtered and if necessary digitized, is connected downstream from video sensor 10. Signal processing unit 13 performs these tasks for video sensor 12. Video sensors 10 and 12 may be for example CCD or CMOS cameras that operate in the infrared range. If they are in the infrared range, infrared illumination may also be provided.

According to the method of the present invention, a processor 14, which is provided in a stereo camera control unit, then processes the data from video sensors 10 and 12 in order to classify the detected object. To accomplish this, processor 14 accesses a memory 15. Individual models characterized by their pixel coordinates and their mutual correspondences are stored in memory 15, e.g., a database. The model having the greatest degree of concordance with the measured object is sought using processor 14. The output value of processor 14 is the classification result, which is for example sent to a restraining means control unit 16, so that as a function of this classification and other sensor values from a sensor system 18, e.g., a crash sensor system, control unit 16 may trigger restraining means 17 (e.g., airbags, seat belts tighteners and/or roll bars).

FIG. 2 shows by way of a diagram how the surface points of a three-dimensional model representing an object to be classified are mapped to the image planes of the two video sensors 10 and 12. Herein, model 21, representing an ellipsoid, is mapped by way of an example. Model 21 is at a defined distance from video sensors 10 and 12. The model points visible to video sensors 10 and 12 are mapped to image planes 23 and 25 of video sensors 10 and 12. By way of an example, this is shown for model point 22, which is at distance z from image planes 23 and 25. In right video sensor image plane 25, model point 22 maps to pixel 26 having pixel coordinates xᵣ and yᵣ, the origin being the center of the video sensor. The left video sensor has a pixel 24 for model point 22 having pixel coordinates x₁ and y₁. Disparity D is the relative displacement between the two corresponding pixels 24 and 26 for model point 22. D is calculated as

D=x₁−xᵣ.

In geometric terms, disparity is D=C/z, where constant C depends on the geometry of the stereo camera. In the present case, distance z from model point 22 to image plane 25 or 23, respectively, is known, as three-dimensional model 21 is situated in a predefined position and orientation relative to the stereo camera.

For each three-dimensional model describing a situation to be classified, in a one-time preprocessing step the pixel coordinates and their mutual correspondences for the model points visible to video sensors 10 and 12 are determined and stored in the look-up table of correspondences.

Classification is performed via comparison of the grayscale distributions in a defined image area surrounding the corresponding left and right camera image pixel coordinates of the stereo camera detecting the object to be classified. This is also feasible for color value distributions.

For each three-dimensional model, the comparison supplies a quality index indicating the degree of concordance between the three-dimensional model and the measured left and right camera images. The three-dimensional model having the most favorable quality index which best describes the measured values produces the classification result.

The quality index may be ascertained using signal processing methods, e.g., a correlation method. If a corresponding three-dimensional model is not generated for every possible position and orientation of the measured object, differences between the position and orientation of the three-dimensional models and those of the measured object may be calculated using iterative adjustment methods, for example.

The classification method may be divided into offline preprocessing and actual online classification. This allows the online processing time to be significantly reduced. In principle, it is also feasible for preprocessing to take place online, i.e., while the device is in operation. However, this would increase the processing time and as a general rule would not have any advantages.

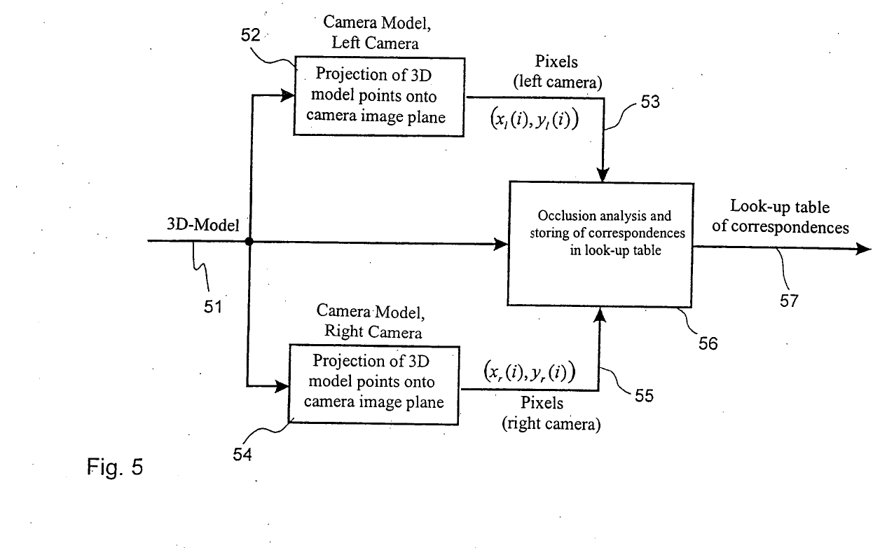

During offline processing, the left and right camera pixel coordinates and their correspondences are determined for each three-dimensional model and stored in a look-up table. FIG. 5 shows this by way of an example for a three-dimensional model 51. The surface of a model of this kind may for example be modeled with the help of a network of triangles, as is shown in FIG. 2 by way of an example for model 21. As shown in FIG. 5, the 3D points on the surface of model 51 are projected onto the camera image plane of the left camera in method step 52 and onto the camera image plane of the right camera in method step 54. As a result, the two corresponding pixels, i.e., pixel sets 53 and 55 of the two video sensors 10 and 12 are then available. In method step 56, pixel sets 53 and 55 are subjected to occlusion analysis, the points of model 51 which are visible to video sensors 10 and 12 being stored in the look-up table. The complete look-up table of correspondences for model 51 is then available at output 57. The offline preprocessing for model 51 shown by way of an example in FIG. 2 is performed for all models which represent objects to be classified and for various positions of these models relative to the stereo camera system.

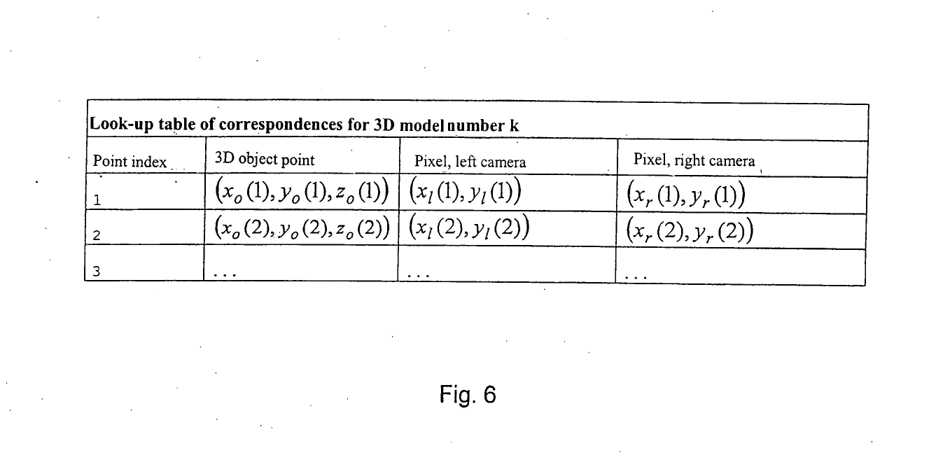

FIG. 6 shows an example of a look-up table for a 3D model located in a specified position relative to the stereo camera system. The first column contains the indices of the 3D model points of which the model is made. The second column contains the coordinates of the 3D model points. The third and fourth columns contain the accompanying left and right video sensor pixel coordinates. The individual model points and the corresponding pixel coordinates are positioned on a line-by-line basis, only model points visible to the video sensors being listed.

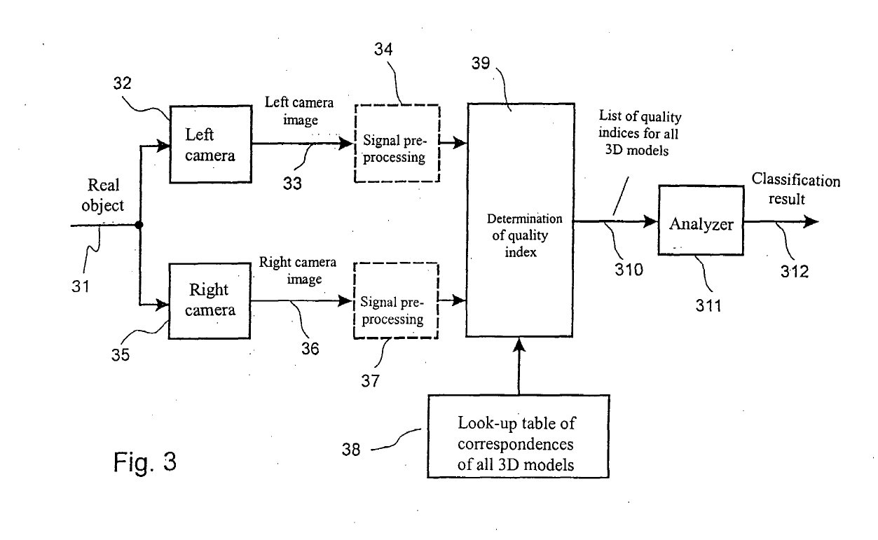

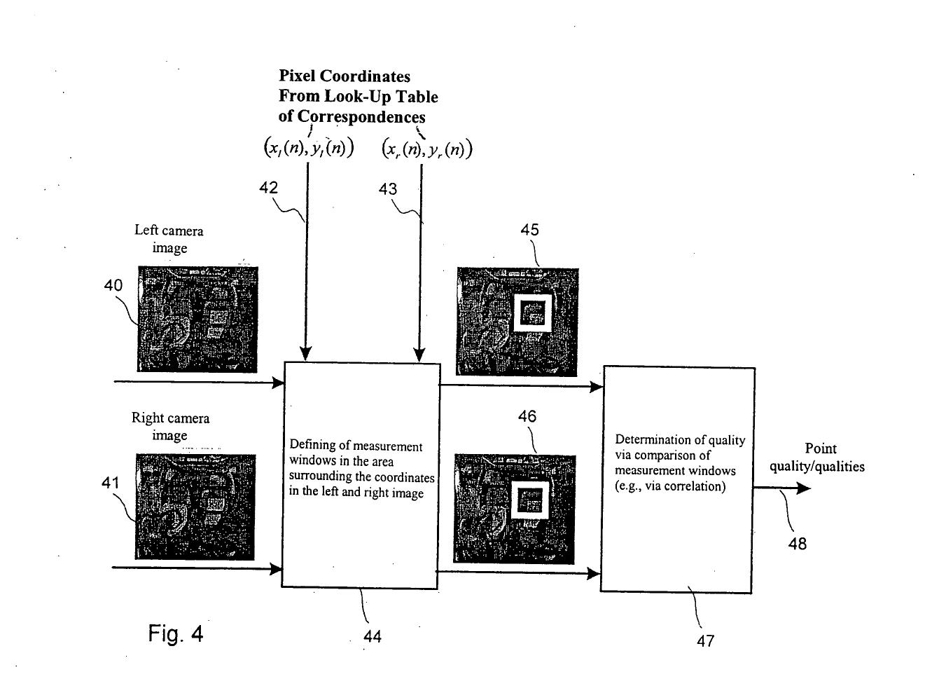

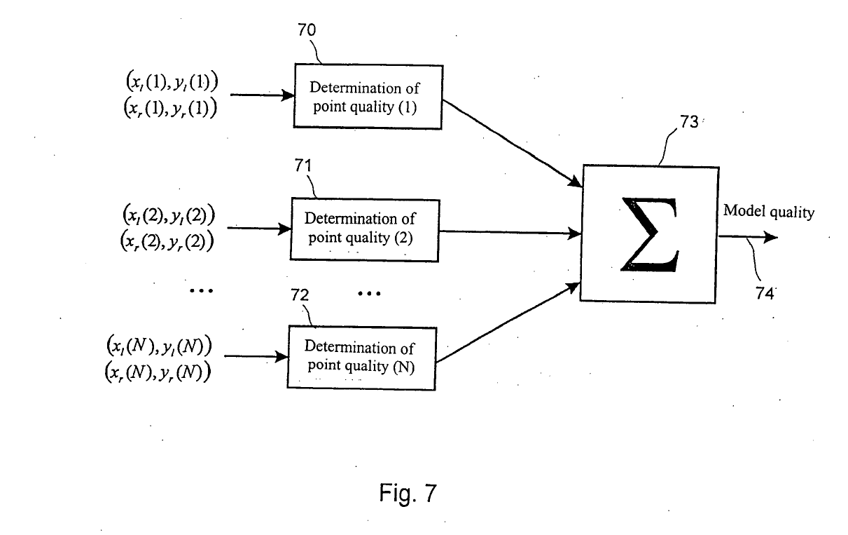

FIG. 3 shows a block diagram of the actual classification performed online. Real object 31 is captured via video sensors 10 and 12. In block 32, the left video sensor generates its image 33 and in block 35 the right video sensor generates its image 36. Then, in method steps 34 and 37, images 33 and 36 are subjected to signal preprocessing. Signal preprocessing is, for example, filtering of captured images 33 and 36. Next, in block 39, the quality index is determined for each three-dimensional object stored in the look-up table in database 38. Images 33 and 36 in prepared form are used for this. An exemplary embodiment of the determination of the quality index is shown in FIG. 4 and FIG. 7. The list having the model quality indices for all the three-dimensional models is then made available at the output of quality index determination block 39. This is shown using reference arrow 310. Then, in block 311, the list is checked by an analyzer, and the quality index indicating the highest degree of concordance is output as the classification result in method step 312.

An option for determining the quality index for a model is described below by way of an example, with reference to FIGS. 4 and 7. Below, this quality index is referred to as the model quality. As explained above, the model qualities for all models are combined to form the list of model quality indices 310. Each model is described via model points which are visible to video sensors 10 and 12 and for which the corresponding pixel coordinates of the left and right video sensors 10, 12 are stored in the look-up table of correspondences. For each model point and accompanying corresponding pixel pair, a point quality which indicates how well the pixel pair in question matches the measured left and right image may be provided.

FIG. 4 shows an example for the determination of point quality for pixel coordinate pair 42 and 43, which is assigned to a model point n. Pixel coordinates 42 and 43 are stored in the look-up table of correspondences. In method step 44, a measurement window is set up in the measured image 40 in the area surrounding pixel coordinates 42 and respectively in the measured right image 41 in the area surrounding pixel coordinates 43. In left and right images 41 and 42 these measurement windows define the areas that are to be included in the point quality determination.

These areas are shown by way of an example in left and right image 45 and 46. Images 45 and 46 are sent to a block 47 so that the quality may be determined via comparison of the measurement windows, e.g., using correlation methods. The output value is then point quality 48. The method shown by way of an example in FIG. 4 for determining point quality 48 for a pixel coordinate pair 42 and 43 assigned to a model point n is applied to all pixel coordinate pairs in look-up table 57 so that a list of point qualities for each model is available.

FIG. 7 shows a simple example for determining the model quality of a model from the point qualities. As described above with reference to FIG. 4, the point qualities for all N model points are calculated as follows: In block 70, the point quality for the pixel coordinate pair of model point number 1 is determined. In block 71 the point quality for the pixel coordinate pair of model point number 2 is determined in an analogous manner. In block 72, finally the point quality for the pixel coordinate pair of model point number N is determined. In this example, model quality 74 of a 3D model is generated via summation 73 of its point qualities.

1-5. (canceled)

6. A method for classifying an object using a stereo camera, comprising:
generating a first image with a first video sensor;
generating a second image with a second video sensor; and
in order to classify the object, comparing the first image and the second image with one another in specifiable areas surrounding corresponding pixel coordinates, the pixel coordinates for at least one model, at least one position, and at least one distance from the stereo camera being available.

7. The method as recited in claim 6, further comprising:
generating a quality index for each individual comparison; and
classifying the object as a function of the quality index.

8. The method as recited in claim 6, further comprising:
generating models for at least two positions and distances relative to the stereo camera.

9. The method as recited in claim 8, further comprising:
storing the models in a look-up table.

10. The method as recited in claim 7, wherein the quality index is generated via correlation.
